(19) United States
(12) Patent Application Publication
(10) Pub. No.: US 2003/0171946 A1
(43) Pub. Date: Sep. 11, 2003

(54) Method and system for continuous sampling of mail

(76) Inventor: Paulette M. Kelly, Arlington, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,849

(22) PCT Filed: Mar. 5, 2002
(86) PCT No.: PCT/US02/05098

(51) Int. Cl. G06F 17/60

(52) U.S. Cl. 705/1

(57) ABSTRACT

Systems and methods are provided for generating a quality report for a mailing or mailer. A mailer executes a number of jobs each job containing a different type or number of submitted mail pieces. The mail pieces of each job is sampled and analyzed to determine the quality of the mailing based on a verification type. The results of the analysis are stored in a database and a report is later generated in response to a request. The report includes information that provides for determining the quality of the submitted mailings or for assessing the quality of mail preparation conducted by the mailer.

### BACKGROUND

This application claims the benefit of priority of U.S. provisional application No. 60/272,760, filed on Mar. 5, 2001, the disclosure of which is hereby expressly incorporated herein by reference.

A. Field

The present invention relates to methods for verifying mail and more particularly, to methods for sampling mail and determining whether the mail complies with postal requirements.

B. Description of the Related Art

The United States Postal Service (USPS) is an independent government agency that provides mail delivery and other services to the public. The USPS seeks to ensure that mail is delivered to its customers in a timely manner. In ensuring timely delivery the USPS may monitor whether mail submitted by mailers complies with USPS requirements. Monitoring the mail of a mailer involves at least two aspects. A first aspect relies on identifying the entity that is presenting the mail (mailer) and a second relies on the number mailings presented by the mailer over the course of one day. Mail verification may be performed by sampling information from mail submitted by the mailer, analyzing the sampled information, and generating a report based on the sample. Performing mail verification in the above manner allows the USPS to determine the quality of mail being submitted by the mailer, and the qualities of mail submitted by the mailer that needs improvement.

FIGS. 1A and 1B are block diagrams of a detached mail unit (DMU) 100A and a business mail entry unit (BMEU) 100B. In FIG. 1A, DMU 100A is a location in a mailer's facility where a USPS employee oversees mail that is submitted to a USPS facility. DMU 100A may include a mailer 110 having jobs 1-3, and an analysis device 120. Jobs 1-3 each may represent a different type of mail or mail from different clients. Analysis device 120 analyzes at least one sample of jobs 1, 2, and 3 and may generate a report for each sample, indicating the overall quality of mail submitted in each job, that is, the degree to which the mail corresponds to USPS standards.

In FIG. 1B, a Business Mail Entry Unit (BMEU) 100B is a facility maintained by the USPS at a USPS facility where a mailer may submit mail. BMEU 100B includes mailer 110 having jobs 1-3, an analysis device 120, and a mailer 130 having additional jobs (not shown). BMEU 100B operates in a manner similar to DMU 100A, however, because BMEU 100B may contain more than one mailer (110 and 130), over the course of a day BMEU 100B may present many more jobs to analysis device 120 than are possible with DMU 100A.

DMU 100A and BMEU 100B may use a mailing evaluation readability lookup instrument (MERLIN) or equivalent as analysis device 120. Although MERLIN can obtain many samples from jobs 1-3, MERLIN can only generate a report for each of the acquired samples. In other words, MERLIN cannot combine data from several samplings so that an interim or final report can be generated. For example, if a mailer submits mail four times in a day, MERLIN will generate four separate reports that indicate whether each mailing is acceptable. Furthermore, MERLIN does not provide information summarizing the performance of the mailer in submitting quality mail.

It is desirable, therefore, to implement a mail verification system whereby data obtained from more than one sample of mail can be combined to generate a single report. Furthermore, this mail verification system can be generated instantly upon request or generated according to a time schedule.

### SUMMARY

Systems and methods consistent with the present invention overcome the shortcomings of conventional systems by gathering samples of mail and generating a single report that surveys how a particular mailer is performing in submitting quality mail throughout the course of one day.

An embodiment consistent with the present invention relates to a method of generating a quality report for a mailing. The method comprising the steps of obtaining a first sample from the mailing, wherein-the first sample includes a first plurality of mail pieces; analyzing the first sample to determine a number of errors in the first plurality of mail pieces; storing the number of errors from the first sample; obtaining a second sample from the mailing, wherein the second sample includes a second plurality of mail pieces; analyzing the second sample to determine a number of errors in the second plurality of mail pieces; storing the number of errors from the second sample; combining the number of errors from the first sample with the number of errors from the second sample to obtain a final error rate; and generating a report that includes the final error rate.

Another embodiment consistent with the present invention relates to a method of determining the quality of a mailing, comprising obtaining a first sample from the mailing, wherein the first sample includes a first plurality of mail pieces; analyzing the first sample to determine a number of errors from the first sample; storing the number of errors from the first sample in a database; obtaining a second sample from the mailing, wherein the second sample includes a second plurality of mail pieces; analyzing the second sample to determine a number of errors from the second sample; storing the number of errors from the second sample in the database; combining the number of errors from the first sample with the number of errors from the second sample to obtain a final error rate; and storing the final error rate in the database.

Another embodiment consistent with the present invention relates to a computer readable medium containing instructions for controlling a processing device to perform a method for generating a quality report for a mailing. The method executed by the computer readable medium comprising the steps of prompting a user to obtain a first sample from the mailing, wherein the first sample includes a first plurality of mail pieces; analyzing the first sample to determine a number of errors in the first plurality of mail pieces; storing the number of errors from the first sample; prompting the user to obtain a second sample from the mailing, wherein the second sample includes a second plurality of mail pieces; analyzing the second sample to determine a number of errors in the second plurality of mail pieces; storing the number of errors from the second sample; combining the number of errors fro the first sample with the number of errors from the second sample to obtain a final error rate; and generating a report that includes the final error rate.

Still another embodiment consistent with the present invention relates to a system for generating a quality report for a mailing. The system comprising means for obtaining a first sample from the mailing, wherein the first sample includes a first plurality of mail pieces; means for analyzing the first sample to determine a number of errors from the first sample; means for storing the number of errors from the first sample; means for obtaining a second sample from the mailing, wherein the second sample includes a second plurality of mail pieces; means for analyzing the second sample to determine a number of errors from the second sample; means for storing the number of errors from the second sample; means for combining the number of errors from the first sample with the number of errors from the second sample to obtain a final error rate; and means for generating a report that includes the final error rate.

The description of the invention and the following description for carrying out the best mode of the invention should not restrict the scope of the claimed invention. Both provide examples and explanations to enable others to practice the invention. The accompanying drawings, which form part of the description for carrying out the best mode of the invention, show several embodiments of the invention, and together with the description, explain the principles of the invention. The objects and advantages of the invention will be realized and attained by means of the elements and combinations particularly pointed out in the appended claims.

Exemplary systems and methods consistent with the present invention are recited in the attached claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the following description, serve to explain the principles of the invention. In the drawings:

FIGS. 1A-1B are block diagrams of report generating systems in accordance with methods and systems of the prior art;

FIGS. 2A-2B are block diagrams illustrating a system for generating reports in accordance with systems and methods consistent with the present invention.

FIG. 3A is an example of report generated in accordance with methods and systems consistent with the present invention;

FIG. 3B is a flow chart of a process for generating a report in accordance with methods and systems consistent with the present invention;

FIG. 4 is a block diagram illustrating a flow of data when generating an interim or final report, in accordance with methods and systems consistent with the present invention;

FIG. 5 is a flow chart of a process for generating an interim or final report in accordance with methods and systems consistent with the present invention; and

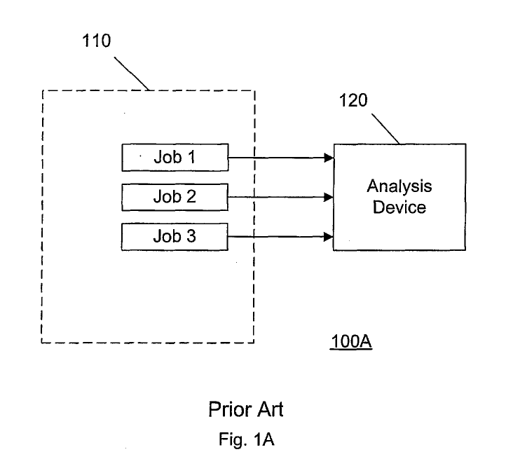

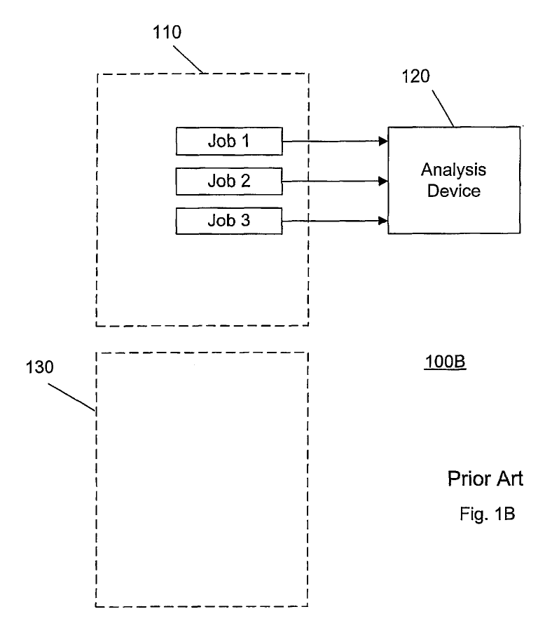

### DESCRIPTION OF THE PREFERRED EMBODIMENTS

In accordance with an embodiment of the present invention, methods and systems are provided for generating a quality report for a mailing. A mailer may execute a number of jobs having a different type or number of submitted mail pieces. These mail pieces are sampled and analyzed so that the quality of the mailing may be determined. The analysis of the mailings is based on a verification type used by the USPS. The results of the analysis are stored in memory and a report is later generated in response to a request. The report includes information that allows the USPS to determine the quality of the submitted mailings or for assessing the quality of mail preparation conducted by the mailer.

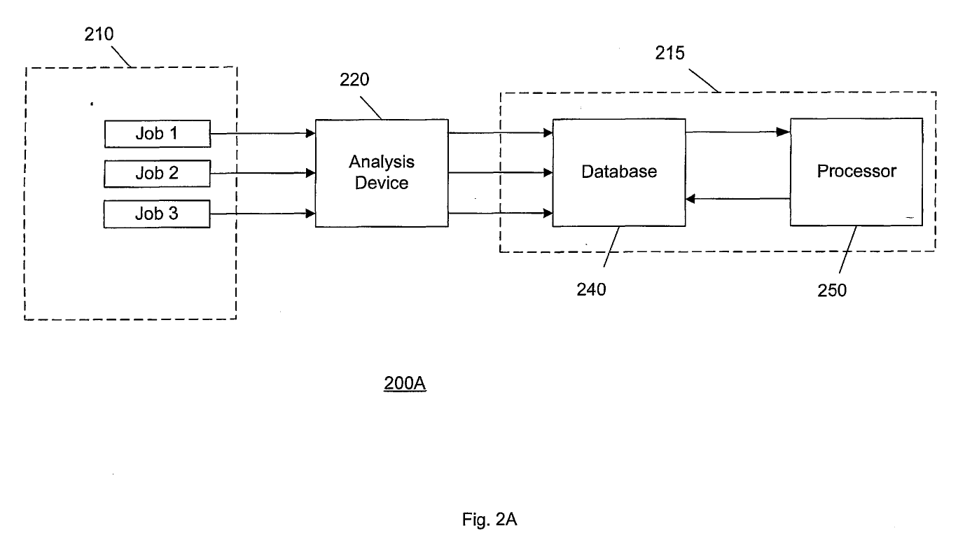

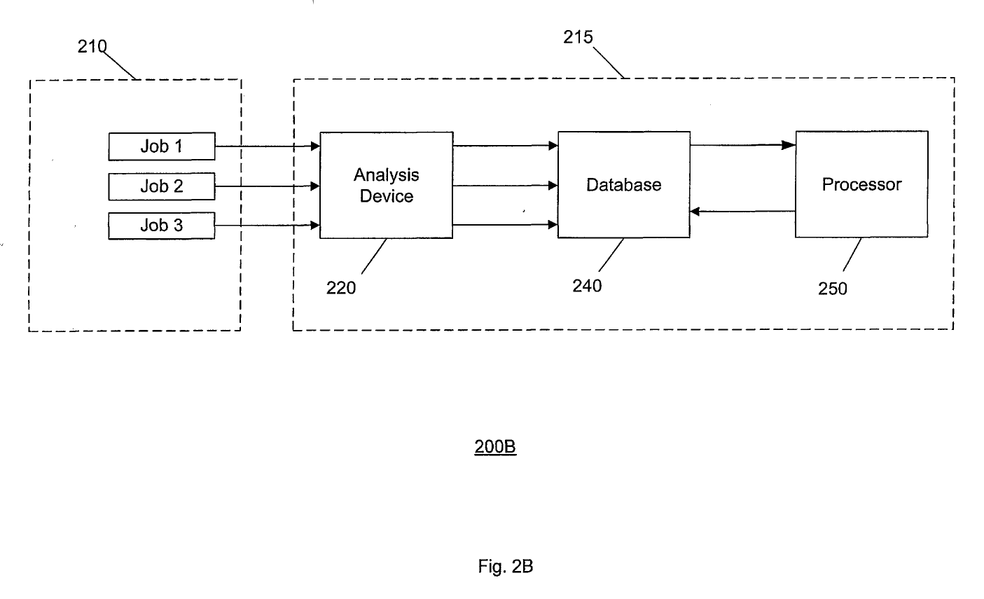

FIGS. 2A and 2B are block diagrams of a system 200A and 200B in accordance with methods and systems consistent with the present invention. In FIG. 2A, system 200A includes a mailer 210 having jobs 1-3, an analysis device 220, and a remote device 215 having a database 240 and a processor 250. Remote device 215 may be any device capable of processing data, for example a personal computer. Database 240 stores the reports generated by analysis device 220 and processor 250 accesses the reports stored in database 240 to generate an interim or final report (not shown).

Mailer 210 provides an output for each of jobs 1-3 to an input of analysis device 220. Analysis device 220 samples and analyzes the data so that a report may be generated. Analysis device 220 may be an automated machine capable of randomly sampling pieces of mail to determine an overall quality of the entire mailing or include human interaction, wherein a postal worker usually inspects randomly selected pieces of mail and enters the associated data into a processing device. Analysis device 220, to be discussed in detail below, provides the report to an input of remote device 215. Database 240 stores the results output from analysis device 220 and provides the stored data to processor 250 upon request. This configuration enables system 200A to perform an analysis on a particular mailer while at the same time sampling a different mailer or mailing. Further details of sampling are contained in U.S. Patent Application No. [______] entitled “Method for Obtaining a Random Sample,” filed on Mar. 5, 2002, by Margaret M. Reese and Thomas M. Amonette. The disclosure of the aforementioned patent application is hereby expressly incorporated herein by reference.

In FIG. 2B, system 200B includes a mailer 210 for executing jobs 1-3, and a remote device 215 having an analysis device 220, a database storage 240, and a processor 250. System 200B is capable of performing the same analysis as described in relation to system 200A, however, analysis device 220 of system 200B is included within remote device 215. Factors that may influence an implementation of system 200A or system 200B are, among other things, network availability, specifications of remote device 215, and location of remote device 215.

Analysis device 220 of systems 200A and 200B generates a report that is used in determining whether a mailing of jobs 1-3 complies with USPS standards. Analysis device 220 analyzes at least one sample of jobs 1, 2, and 3, and may also obtain and analyze multiple samples of jobs 1-3. Analysis device 220 may further provide a random sampling selector (not shown) that identifies which sample should be taken, and where the identified sample is located. For example, if mailer 210 has the capability to produce mailings for several clients, and each client has a number of different types of mail and different mailing lists, among other things, analysis device 220 may provide the user with a time and location for sampling the jobs of each client.

In instances where mailings and postage statements are presented at the same time, analysis device 220 may take a sample based on the size of the mailing. For example, if job 1 contained 10,000 or more pieces of mail, analysis device 220 may randomly select 1800 of the 10,000 pieces for a sample, or if job 1 contains less than 10,000 pieces of mail, analysis device 220 may randomly select 500 of the 10,000 pieces for a sample. Each time mailer 210 executes job 1, 2, or 3, analysis device 220 may take a sample and send the report to database 240 for storage.

In the event job 1, 2, or 3 includes a very large amount of mailings, analysis device 220 may take more than one sample at a particular instant so that the samples accurately reflect the composition of the entire mailing. For example, if job 1 includes at least one million pieces of mail, analysis device 220 may sample 200 pieces of mail every hour for nine hours. By sampling the content of job 1 in this manner, analysis device 220 may provide a better picture of the overall quality of the mailings than otherwise obtainable through a single sample of 1800 pieces. Furthermore, by taking multiple samplings of job 1 and combining the data from each sample, the report generated by system 200A or 200B allows the USPS to make a more accurate determination of the performance of each mailer. Particularly, the combined samples of job 1 enable the USPS to rate the performance of a mailer using a risk factor. This risk factor measures the performance of the mailer with respect to the quality of mailings submitted by the mailer. For example, a mailer that submits mail having a good quality across all of its mailings would typically have a risk factor that is lower than a mailer that has presented at least one mailing of bad quality.

Analysis device 220 may further perform multiple samplings according to verification types, which may include bar codes, mail makeup, print quality, etc. Analysis device 220 performs multiple sampling on the mailings provided by a mailer as described above. If a user requests a report on a single mailing, for example, the report may indicate that mailer 210 has a poor bar code quality in job 2. Based on the values in the report indicating the bar code quality of mailings in jobs 1 and 3, the user may determine whether the bar codes of the mailings in job 2 comply with USPS requirements.

It is well known that a BMEU, such as BMEU 100B, may be configured as a “continuous mailer” or a “presort house,” also known as a “lettershop.” A continuous mailer may present mail to the USPS throughout the day, and may further present one postage statement for all mail submitted on that day to the USPS. Lettershops, on the other hand, may present multiple mailings to the USPS over the course of one day. When the present invention is implemented in a continuous mailer configuration, analysis device 220 may periodically sample a small portion of mail and store the sample in database storage 240. Once the continuous mailer submits the last mailing of the day, analysis device 220 may compare the acquired samples against at least one of a postage statement or other mailer documentation of the continuous mailer. On the other hand, when the present invention is implemented in a letter shop configuration, system 200A or 200B may analyze the mailings of the lettershop according to the process described above, or may prompt the user to create a database for each lettershop based on the type of information presented in each mailing. The creation of individual databases allows a report to be generated that presents the quality of mailings for any number of lettershops that may have submitted mail. Such a report may allow the USPS to assess risk factors that summarize the results of the report.

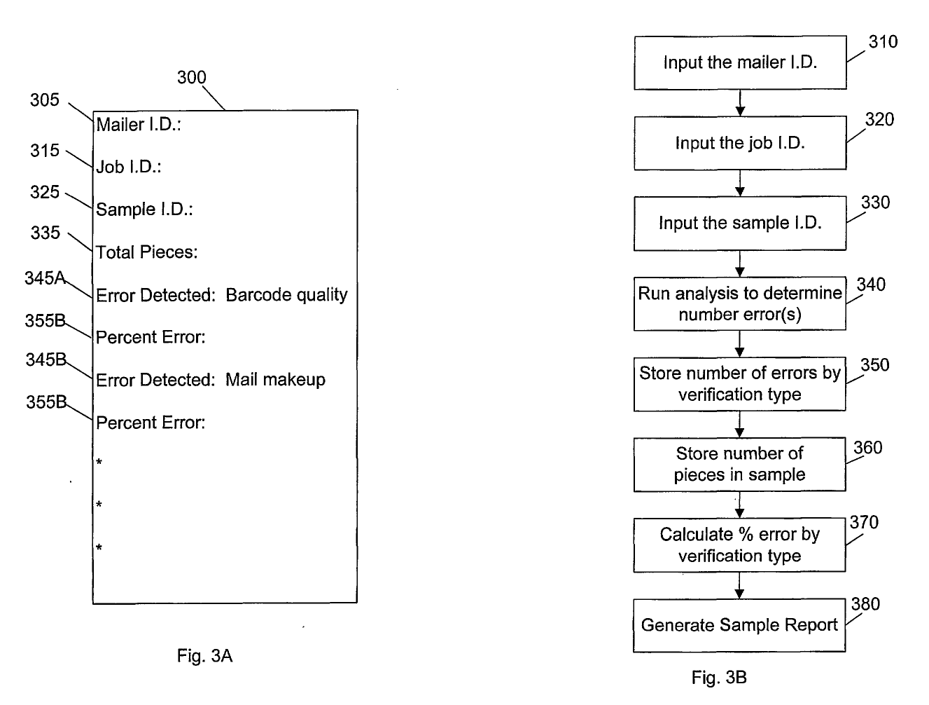

FIG. 3A shows an example of a report 300 generated in accordance with methods and systems consistent with the present invention. Report 300 may have a number of headings providing information to a user regarding the quality of the mail contained within a job. These headings include a Mailer identification (ID) 305, a Job identification (ID) 315, a Sample identification (ID) 325, a total number of pieces (Total Pieces) 335, a number of errors detected (Error Detected) 345A and 345B, and a percent error rate (Percent Error) 355A and 355B. Mailer identification 305 may be a unique alphanumeric string that distinguishes each mailer from one another. Job ID 315 may be an alphanumeric string that uniquely identifies each job of a particular mailer. Sample ID 325 is a character string that distinguishes each sample within a particular job. Total Pieces 335 indicates the total number of pieces in the sample, and Error Detected 345A and 345B indicate the number of errors detected for a specific verification type (e.g., “Barcode Quality” and “Mail makeup”). Finally, percent error 355A and 355B are calculated based on the values of error detected 345A and 345B, respectively, and total pieces 335. Percent error 355A and 355B indicate the percentage error for specific verification types of the sample.

FIG. 3B is a flow chart of a process used by system 200A or 200B for generating a report in accordance with methods and systems consistent with the present invention. At step 310, a user may enter mailer ID 305. Next at step 320, the user may enter job ID 315. Sample ID 325 is entered at step 330. Once steps 310-330 are executed, analysis device 220 performs an analysis to determine the number of errors that are present within the sample (step 340). At step 350, database 240 stores, by verification type, the number of errors identified based on the completed analysis. The number of errors stored for each verification type correspond to the values of error detected 345A and 345B, respectively. At step 360, database 240 stores the number of pieces that are present within the sample, corresponding to total pieces 335. Next, at step 370, analysis device 220 calculates, for each verification type, the percent error of the total number of errors detected, corresponding to percent error 355. Finally, at step 380, remote device 215 generates the sample report 300 based on a request of the user and the data stored in database 240 for each verification type.

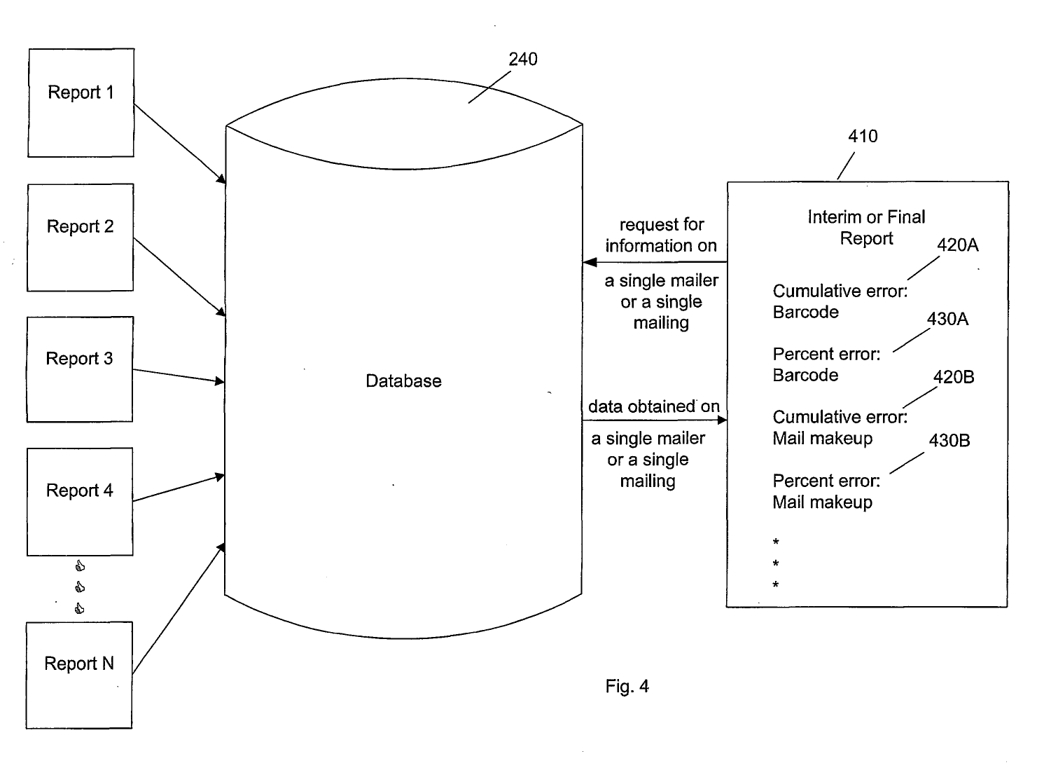

FIG. 4 is a block diagram illustrating the flow of data when system 200A or 200B generates an interim or final report 410 in accordance with systems and methods of the present invention. Database 240 stores sample reports 1 through N generated by analysis device 220. Database 240 may further update reports 1 through N, when new data associated with a particular report is provided by analysis device 220. A user may request system 200A or 200B to generate a report pertaining to a single mailer or single mailing based on any of reports 1 through N stored in database 240. Upon receiving the user's request, processor 250 retrieves from database 240 all reports having information corresponding to the request and generates a report 410. For each verification type, report 410 includes cumulative error headings 420A and 420B, respectively, and percent error headings 430A and 430B, respectively. Cumulative error 420A and 420B indicate the number of errors recorded at the time of the request and percent error 430A and 430B indicate the percentage error for each verification type based on the total number of errors recorded for all verification types at the time of the request. From the information provided in report 410, the USPS may determine the quality of a single mailing or assess a risk factor to a single mailer.

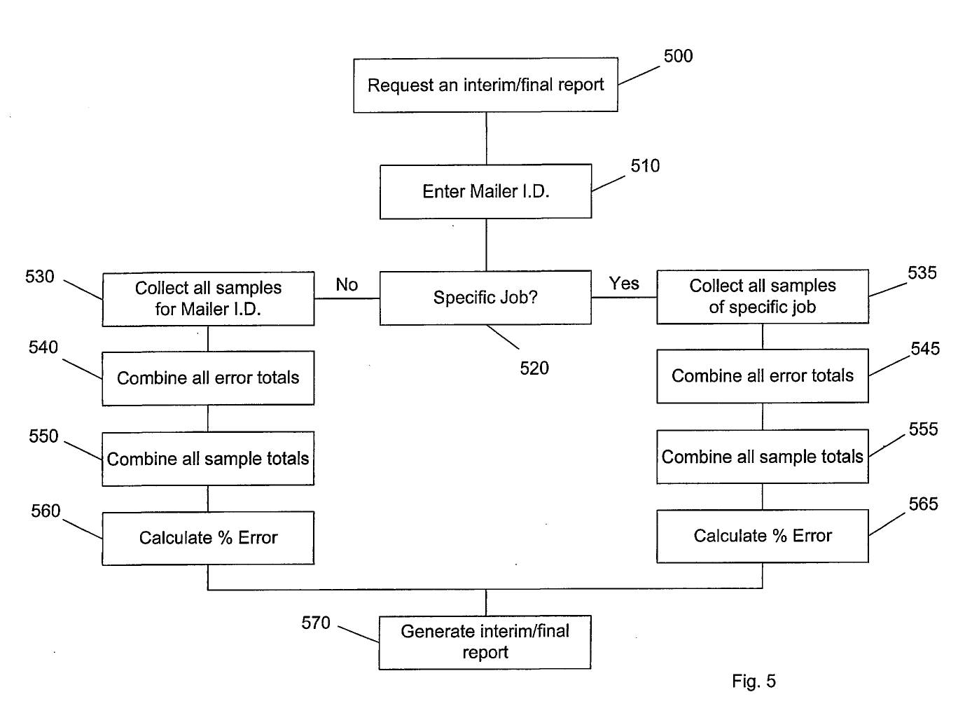

FIG. 5 is a flow chart of a process for generating report 410, in accordance with systems and methods consistent with the present invention. Initially, at step 500, a user issues a request for an interim or final report. Next, at step 510, remote device 215 prompts the user to enter mailer ID 305. At step 520, remote device 215 presents to the user an option of entering job ID 315. If the user does not enter a value for job ID 315 then, at step 530 processor 250 obtains from database 240, all report data corresponding to the entered mailer ID. Processor 250 then combines all error totals (step 540), combines all sample totals (step 550), and calculates a percent error (step 560). Alternatively, if the user enters a value for job ID 315 then, at step 535, processor 250 obtains from database 240, all report data corresponding to the entered job ID. Processor 250 then combines all error totals (step 545), combines all sample totals (555), and calculates a percent error (step 565). Finally, at step 570, processor 250 generates report 410 that presents the combined data to the user.

In another embodiment, the present invention may be implemented as a software application. The application may instruct appropriate USPS personnel to gather a sample of mail from a specific place within a mailer facility and process the sample so that it is recorded into the system. Once the mail is processed, the application may analyze the information from the mailing, and generate an interim report based on the information. Later, USPS personnel may gather a second sample from the same mailer facility and process the sample for analysis by the application. The software may then combine the data of the first and second sample and generate a single report. This report provides an overall comprehensive view of the performance of the mailer in submitting quality mail to the USPS facility.

The embodiments of the invention as described provide a mail analysis verification device with the capability to store data corresponding to an individual mailing, add additional data, and generate an interim or final report based on both sets of data. Moreover, the generated report enables the USPS to determine whether a mailer is submitting mail that complies with postal guidelines. Furthermore, the invention may be used in conjunction with MERLIN to upload data in real-time to a national database such as Postal One!™. Postal One!™ contains summary information on certain aspects of a particular postal facility. The present invention may incorporate additional aspects into Postal One!™ to further enhance summarizing capabilities of the database. This additional information further enables multiple user facilities to track submitted mailings of a mailer from any USPS facility with access to the database.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of generating a quality report for a mailing, the method comprising:
obtaining a first sample from the mailing, wherein the first sample includes a first plurality of mail pieces;
analyzing the first sample to determine a number of errors in the first plurality of mail pieces;
storing the number of errors from the first sample;
obtaining a second sample from the mailing, wherein the second sample includes a second plurality of mail pieces;
analyzing the second sample to determine a number of errors in the second plurality of mail pieces;
storing the number of errors from the second sample;
combining the number of errors from the first sample with the number of errors from the second sample to obtain a final error rate; and
generating a report that indicates the final error rate.

2. The method according to claim 1, further comprising:
counting the number of pieces in the first sample;
counting the number of pieces in the second sample; and
combining the number of pieces in the first sample with the number of pieces in the second sample to obtain a total number of pieces sampled; and
wherein generating the report includes printing the total number of pieces sampled.

3. A method of determining the quality of a mailing, the method comprising:
obtaining a first sample from the mailing, wherein the first sample includes a first plurality of mail pieces;
analyzing the first sample to determine a number of errors from the first sample;
storing the number of errors from the first sample in a database;
obtaining a second sample from the mailing, wherein the second sample includes a second plurality of mail pieces;
analyzing the second sample to determine a number of errors from the second sample;
storing the number of errors from the second sample in the database;
combining the number of errors from the first sample with the number of errors from the second sample to obtain a final error rate; and
storing the final error rate in the database.

4. The method according to claim 3, further comprising:
counting the number of pieces in the first sample;
storing the number of pieces in the first sample in the database;
counting the number of pieces in the second sample;
storing the number of pieces in the second sample in the database;
combining the number of pieces in the first sample with the number of pieces in the second sample to obtain a total number of pieces; and
storing the total number of pieces in the database.

5. The method of claim 4, wherein when the mailer submits a plurality of mailings the method further comprises:
combining the final error rate for each of the plurality of mailings into a mailer total error rate;
storing the mailer total error rate in the database;
combining the total number of mail pieces for each of the plurality of mailings into a total number of mail pieces for the mailer;
storing the total number of mail pieces for the mailer in the database; and
generating a report including the mailer total error rate and the total number of mail pieces for the mailer.

6. A method for generating a quality report for a mailer, wherein the mailer submits a plurality of mailings; the method comprising:
obtaining a final error rate for each of the plurality of mailings;
combining the final error rate for each of the plurality of mailings into a mailer total error rate;
storing the mailer total error rate in the database; and
generating a report that includes the mailer total error rate.

7. A computer readable medium that contains instructions for controlling a process to perform a method for generating a report for a submitted mailing, the method comprising:
prompting a user to obtain a first sample from the mailing, wherein the first sample includes a first plurality of mail pieces;
analyzing the first sample to determine a number of errors in the first plurality of mail pieces;
storing the number of errors from the first sample;
prompting the user to obtain a second sample from the mailing, wherein the second sample includes a second plurality of mail pieces;
analyzing the second sample to determine a number of errors in the second plurality of mail pieces;
storing the number of errors from the second sample;
combining the number of errors from the first sample with the number of errors from the second sample to obtain a final error rate; and
generating a report that includes the final error rate.

8. A system for generating a quality report for a mailing comprising:
means for obtaining a first sample from the mailing, wherein the first sample includes a first plurality of mail pieces;
means for analyzing the first sample to determine a number of errors from the first sample;
means for storing the number of errors from the first sample;
means for obtaining a second sample from the mailing, wherein the second sample includes a second plurality of mail pieces;
means for analyzing the second sample to determine a number of errors from the second sample;
means for storing the number of errors from the second sample;
means for combining the number of errors from the first sample with the number of errors from the second sample to obtain a final error rate; and
means for generating a report that indicates the final error rate.
